(19) United States
(12) Patent Application Publication
(10) Pub. No.: US 2021/0129673 A1
(43) Pub. Date: May 6, 2021

(54) INPUT DEVICE

(71) Applicant: DENSO CORPORATION, Kariya-city (JP)

(72) Inventor: Tetsuya TOMARU, Kariya-city (JP)

(21) Appl. No.: 17/147,571

(22) Filed: Jan. 13, 2021

Related U.S. Application Data
(63) Continuation of application No. PCT/JP2019/024188, filed on Jun. 19, 2019.

(30) Foreign Application Priority Data
Jul. 17, 2018 (JP) 2018-134403

(51) Int. Cl. B60K 37/02; G06F 3/0481; G06F 3/0488

(52) U.S. Cl. CPC B60K 37/02; B60K 2370/152; G06F 3/0488; G06F 3/04817

(57) ABSTRACT

An input device includes a display unit, a detection unit, and a press detection unit. The display unit is provided on a predetermined device mounted on a vehicle and displays information related to the vehicle. The detection unit detects a position of an operation body on an operation surface. The press detection unit detects a press state of the operation body on the operation surface. The input device causes the display unit to display a plurality of operation icons for input operation. The input device associates the operation body on the operation surface with one of the plurality of operation icons. The input device performs an input to the predetermined device according to an operation state of the operation body detected by the detection unit and the press detection unit.

### CROSS REFERENCE TO RELATED APPLICATIONS

The present application is a continuation application of International Patent Application No. PCT/JP2019/024188 filed on Jun. 19, 2019, which designated the U.S. and claims the benefit of priority from Japanese Patent Application No. 2018-134403 filed on Jul. 17, 2018. The entire disclosures of all of the above applications are incorporated herein by reference.

### TECHNICAL FIELD

The present disclosure relates to an input device that enables an input operation by an operation body.

### BACKGROUND

Input devices which have been proposed include a touch pad and a touch panel. For example, one of the input devices includes a general-purpose operation reception unit and a display. The general-purpose operation reception unit may include a D-pad for input operation and a plurality of buttons. The display may show a plurality of operation contents (for example, an application) for various in-vehicle devices.

### SUMMARY

An input device includes a display unit, a detection unit, and a press detection unit. The display unit is provided on a predetermined device mounted on a vehicle and displays information related to the vehicle. The detection unit detects a position of an operation body on an operation surface. The press detection unit detects a press state of the operation body on the operation surface. The input device causes the display unit to display a plurality of operation icons for input operation. The input device associates the operation body on the operation surface with one of the plurality of operation icons. The input device performs an input to the predetermined device according to an operation state of the operation body detected by the detection unit and the press detection unit.

### BRIEF DESCRIPTION OF DRAWINGS

The features and advantages of the present disclosure will become more apparent from the following detailed description made with reference to the accompanying drawings. In the drawings:

FIG. 1 is an explanatory diagram showing an input device mounted on a vehicle;

FIG. 2 is a block diagram showing a configuration of the input device;

FIG. 3 is an explanatory diagram showing a display unit;

FIG. 4 is a front view showing an operation surface;

FIG. 5 is a perspective view showing the operation surface;

FIG. 6 is an explanatory diagram showing a display example in an icon display area;

FIG. 7 is an explanatory diagram showing a display example in an icon display area;

FIG. 8 is an explanatory diagram showing a display example in an icon display area;

FIG. 9 is an explanatory diagram showing a display example in an icon display area;

FIG. 10 is a diagram showing a relationship between a state of the vehicle and an arrangement to each sections;

FIG. 11 is a diagram showing transition of the state of the vehicle;

FIG. 12 is a flowchart showing an arrangement to each sections according to the state of the vehicle; and

FIG. 13 is a flowchart showing an input control for a finger operation on the operation surface.

### DETAILED DESCRIPTION

For example, an input device displays a plurality of operation contents for various in-vehicle devices. The plurality of operation contents are divided into a plurality of categories. The input device changes priorities of the categories according to vehicle states (for example, traveling, stopping, traveling in high-speed, parking, traveling at night). The input device determines, as contents to be notified, contents frequently operated by the user among the plurality of contents. That is, the contents that can be operated by a general-purpose operation reception unit is set based on the priority and the operation frequency. Thus, the operation load is reduced.

The input device enables a user to operate contents used frequently as described above. However, the plurality of contents are displayed at the same time and a lot of information is displayed on the screen. There is a possibility that information is overload (that is, eyesore) and interferes with safe driving.

The present disclosure provides an input device which displays information that is not eyesore and can reduce an operation load.

An exemplary embodiment of the present disclosure provides an input device that includes a display unit, a detection unit, a press detection unit, and a control unit. The display unit is provided on a predetermined device mounted on a vehicle and configured to display information related to the vehicle. The detection unit is configured to detect a position of an operation body on an operation surface. The press detection unit is configured to detect a press state of the operation body on the operation surface. The control unit is configured to (i) cause the display unit to display a plurality of operation icons for input operation, (ii) associate the operation body on the operation surface with one of the plurality of operation icons, and (iii) perform an input to the predetermined device according to an operation state of the operation body detected by the detection unit and the press detection unit. The operation surface includes a general area and a sectioned area having a plurality of sections. The general area corresponds to an area of the display unit which displays the plurality of operation icons and each of the plurality of sections corresponds to an area of the display unit which displays a selection icon selected from the plurality of operation icons. Each of the plurality of sections is provided with a perception unit configured to give a perception to the operation body when the operation body touches the perception unit. The control unit causes the display unit to hide the plurality of operation icons corresponding to the general area until a predetermined operation is performed by the operation body on the general area. The control unit causes the display unit to display the selection icon by changing an assignment of the selection icon according to a vehicle state.

In the exemplary embodiment of the present disclosure, the control unit hides the plurality of operation icons corresponding to the general area in the display unit until a predetermined operation by the operation body is performed on the general area. Thus, there is no information overload for the operator. The operator can cause the display unit to display the plurality of operation icons by performing the predetermined operation on the general area as necessary.

The control unit changes the assignment of the selection icon for each of the plurality of sections according to the state of the vehicle and causes the display unit to display the selection icon. Thus, the control unit can select the icons suitable for the state of the vehicle among the plurality of the operation icons and improve the operability. In addition, since the protrusion unit is provided on each of the plurality of sections, the operator can operate each of the plurality of sections by the feeling of the finger without directly looking at the plurality of sections. Thus, the configuration can improve the operability. The configuration can suppress eyesore for overloaded information and reduce an operation load.

The following will describe embodiments for carrying out the present disclosure with reference to the drawings. In each embodiment, a constituent element corresponding to a constituent element in a preceding embodiment with a reference sign or numeral may be denoted by the same reference sign or numeral, to omit redundant explanation. When only a part of a configuration is described in an embodiment, another preceding embodiment may be applied to the other parts of the configuration. It may be possible not only to combine parts the combination of which is explicitly described in an embodiment, but also to combine parts of respective embodiments the combination of which is not explicitly described if any obstacle does not especially occur in combining the parts of the respective embodiments.

### First Embodiment

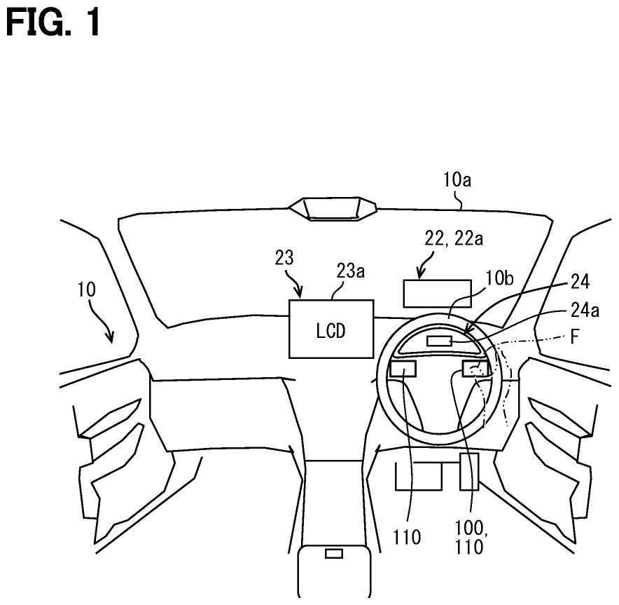

FIG. 1 to FIG. 13 show an input device 100 according to a first embodiment. The input device 100 of the present embodiment is applied to a remote operation device for operating various vehicle devices. The input device 100 is mounted on a vehicle 10 along with various vehicle devices.

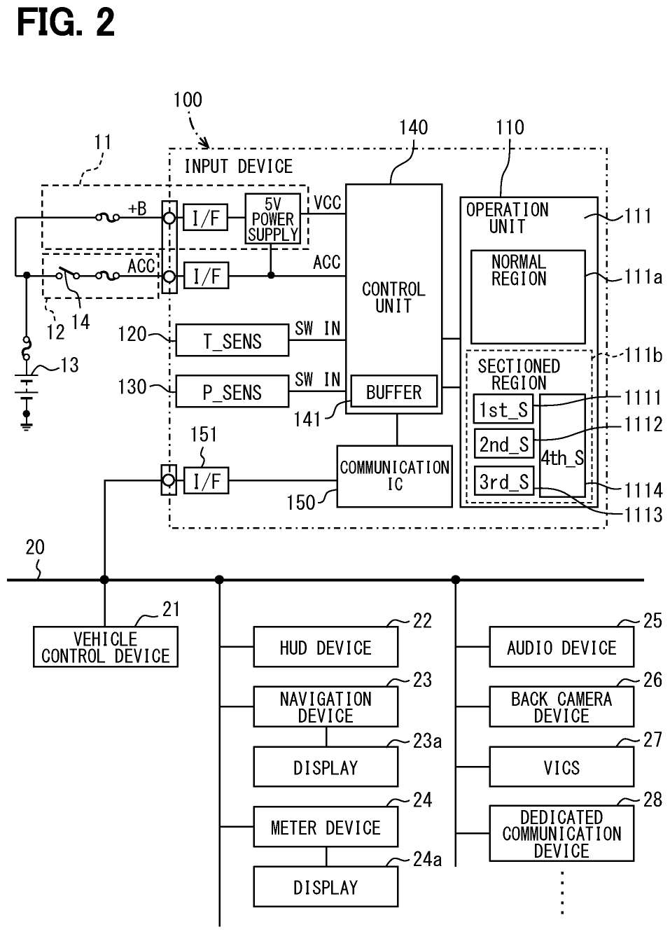

As shown in FIGS. 1 and 2, a constant power supply circuit 11 and an accessory power supply circuit 12 are connected to the input device 100 (a control unit 140 described later). The constant power supply circuit 11 connects a battery 13 and the control unit 140. The constant power supply circuit 11 is a circuit that supplies constant power supply (5V) from the battery 13 to the control unit 140. Further, the accessory power supply circuit 12 connects the battery 13 and the control unit 140 via an accessory switch 14. When the accessory switch 14 is turned on, the accessory power supply is supplied to the control unit 140.

Each of the various vehicle devices corresponds to a predetermined device of the present disclosure. The various vehicle devices may include a head-up display device (hereinafter, HUD device) 22 controlled by the vehicle control device 21, a navigation device 23, a meter device 24, an audio device 25, a back camera device 26, a vehicle information and communication system (VICS, registered trademark) 27, and a dedicated communication device 28.

The vehicle control device 21 and the vehicle devices 22 to 28 are provided separately from the input device 100, and are set at a position away from the input device 100. The vehicle control device 21, the vehicle devices 22 to 28, and the input device 100 may be connected by a controller area network bus 20 (CAN bus, registered trademark). The CAN bus 20 is an in-vehicle network system for realizing information exchange between in-vehicle devices using a predetermined protocol.

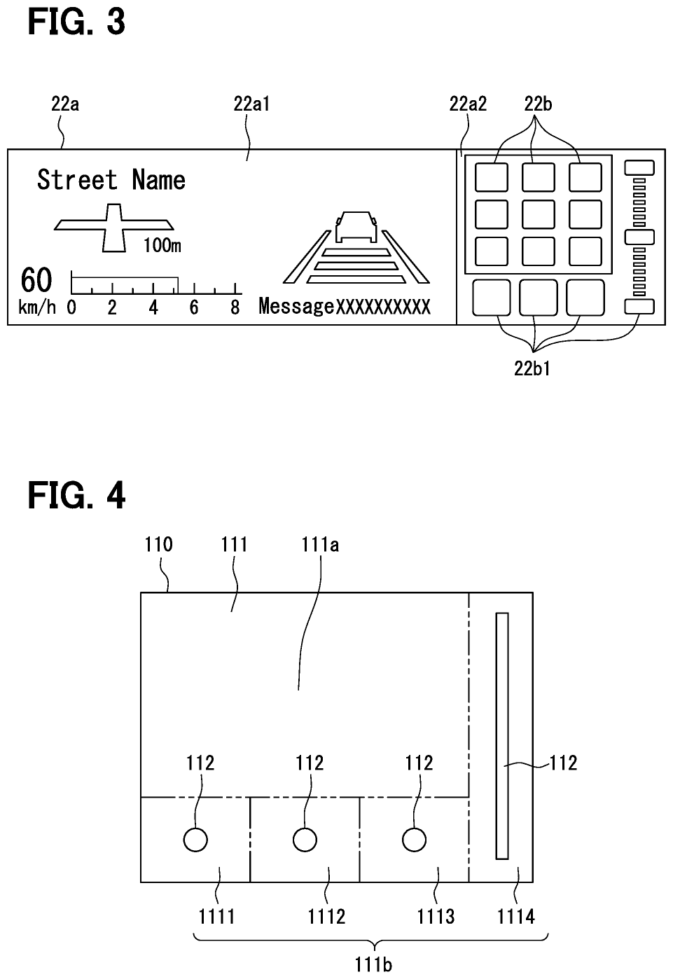

As shown in FIGS. 1 and 3, the HUD device 22 projects a virtual image (information related to the vehicle) for the operator onto a front window 10a of the vehicle 10 to form the display unit 22a. In the present embodiment, the display unit 22a includes an information display area 22a1 and an icon display area 22a2.

Various vehicle information is displayed in the information display area 22a1. The various vehicle information may include a name of road on which the vehicle is traveling, vehicle speed, engine speed, operation state of cruise control, a message.

Further, in the icon display area 22a2, operation icons 22b and selection icons 22b1 used at the time of remote control are displayed. The plurality of operation icons 22b are shown in an upper left area including the central portion of the icon display area 22a2. The plurality of operation icons 22b are preset and fixed icons. Further, selection icons 22b1 (for example, four) are shown in the lower side and the right side of the icon display area 22a2. The selection icons 22b1 are assigned by being selected from the plurality of operation icons 22b according to the state of the vehicle 10 described later.

The navigation device 23 has a center display 23a arranged at the center of the instrument panel of the vehicle 10. Further, the meter device 24 has an in-meter display 24a arranged in the display area. The various operation icons 22b and the selection icons 22b1 may be displayed on the center display 23a or the in-meter display 24a instead of the display unit 22a of the HUD device 22 described above.

The input device 100 is provided on the steering wheel 10b of the vehicle 10. The input device 100 includes an operation unit 110, a touch sensor (T_SENS) 120, a push sensor (P_SENS) 130, a control unit 140, a communication IC 150, and the like.

The operation unit 110 forms a well-known touch pad, and serves as a portion for executing the input operation to the vehicle devices 22 to 28. The operation unit 110 may be provided at a horizontal spoke portion of the steering wheel 10b, and at each of the left and right ends of the of the steering wheel 10b in a state where the steering angle is zero (horizontal state). The operator can operate the operation unit 110 by extending a predetermined finger F (for example, the thumb) to the operation unit 110 (operation surface 111) while holding the steering wheel 10b. Hereinafter, the operation unit 110 will be described with the operation unit 110 on the right end of the left and right ends of the steering wheel 10b as an example.

The surface of the operation unit 110 on which the finger operates (the surface on the operator) is the operation surface 111. The operation surface 111 is exposed toward the operator, and has a planar shape on which the operator performs a finger operation. For example, a material that improves finger sliding over an entire surface of the operation surface 111 may be placed on the operation surface. On the operation surface 111, input of an operation (selection, pushing operation, or the like) to the various operation icons 22b and selection icons 22b1 displayed on the display unit 22a can be performed by the finger operation of the operator.

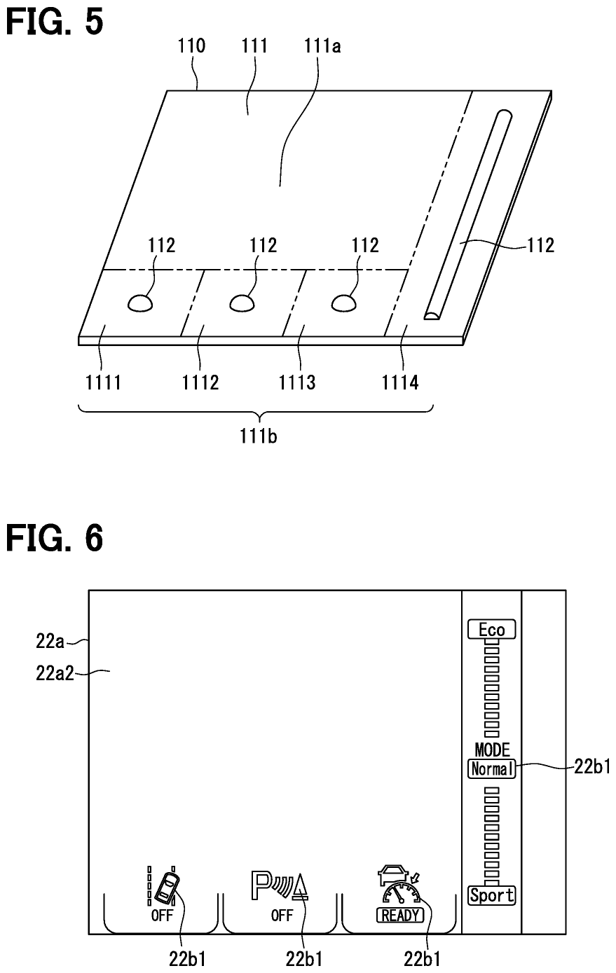

As shown in FIGS. 4 and 5, the operation surface 111 has a quadrangular shape. A general area 111a and a sectioned area 111b are defined in the operation surface 111.

The general area 111a is provided on an upper left area including the central portion of the operation surface 111. The general area 111a corresponds to an area of the display unit 22a which displays the plurality of operation icons 22b. Further, the sectioned area 111b is provided on the lower side and the right side in the operation surface 111. Further, the sectioned area 111b provides a first section (1st_S) 1111, a second section (2nd_S) 1112, and a third section (3rd_S) 1113 on the lower side, and a fourth section (4th_S) 1114 on the right side. The sectioned area 111b (each section 1111 to 1114) corresponds to an area of the display unit 22a in which assigned selection icons 22b1 among the operation icons 22b are displayed.

Each of the sections 1111 to 1114 is provided with a perception unit that gives a perception to the finger F when the operator's finger F comes into contact with each of the sections 1111 to 1114. Here, the perception unit is formed as a protrusion unit 112 protruding toward the operator. The protrusion unit 112 provided on each section 1111 to 1113 has a dome shape and is arranged in the center of each section 1111 to 1113. Further, the protrusion unit 112 provided in the fourth section 1114 has a rod shape with a semicircular cross section, and is arranged along the virtual center line in the longitudinal direction of the fourth section 1114.

The perception unit may be formed as a recess recessed inside the operation surface 111 instead of the protrusion unit 112 as described above. Alternatively, the perception unit may be a vibrating element or the like that gives vibration to the finger F. Alternatively, the perception unit may be a sound unit that generates sound.

For example, the touch sensor 120 is a capacitance type detector placed on a back side of the operation surface 111. The touch sensor 120 has a rectangular flat plate shape, and detects an operation position of the finger F of the operator performed on the operation surface 111. The touch sensor 120 corresponds to a position detection unit of the present disclosure. The touch sensor 120 also corresponds to a position sensor of the present disclosure.

The touch sensor 120 includes an electrode arranged extending along an x-axis direction on the operation surface 111 and an electrode arranged extending along a y-axis direction, and the two electrodes are arranged in a grid shape. As shown in FIG. 2, these electrodes are connected to the controller 140. A capacitance generated by each electrode changes in accordance with an approach of the finger F of the operator toward the operation surface 111. A signal (position signal) of the generated capacitance is output to the control unit 140. The surface of the touch sensor 120 is covered with an insulation sheet made of insulation material. The touch sensor 120 is not limited to the capacitance type sensor. Other types, such as a pressure sensitive type sensor can be employed as the touch sensor.

A change in a coordinate position of the finger F on the operation surface 111 is associated with a selection position of one of the operation icons 22b and selection icons 22b1 displayed on the display unit 22a.

The push sensor 130 may be an element that converts a force applied to a piezoelectric body into a voltage (induced voltage) or converts the voltage into a force. The push sensor 130 is also called a piezo element. The push sensor 130 is provided on the back surface side of the operation surface 111. The push sensor 130 detects a pressing state due to pressing the operation surface 111 when the finger operates. Specifically, the push sensor 130 generates an induced voltage or current (pressing signal) according to the force applied by the finger F. The push sensor 130 corresponds to a press detection unit of the present disclosure. The push sensor 130 corresponds to a press detection sensor of the present disclosure.

The push sensor 130 is connected to a control unit 140 described later as shown in FIG. 2, and outputs the generated induced voltage or current (pressing signal) to the control unit 140. As the press detection unit, an electromagnetic actuator, such as a voice coil motor may be used instead of the push sensor 130.

The control unit 140 includes a CPU, a RAM, and a storage medium, or the like. The buffer 141 is a data area reserved in the RAM. From each signal (position signal and pushing signal) acquired from the touch sensor 120 and the push sensor 130, the control unit 140 acquires, as the operation state of the finger F of the operator, the position of the finger F on the operation surface 111 and the presence or absence of the pressing operation. Then, the control unit 140 gives an instruction to the vehicle control device 21 for input operation to various vehicle devices 22 to 28 according to these operation states.

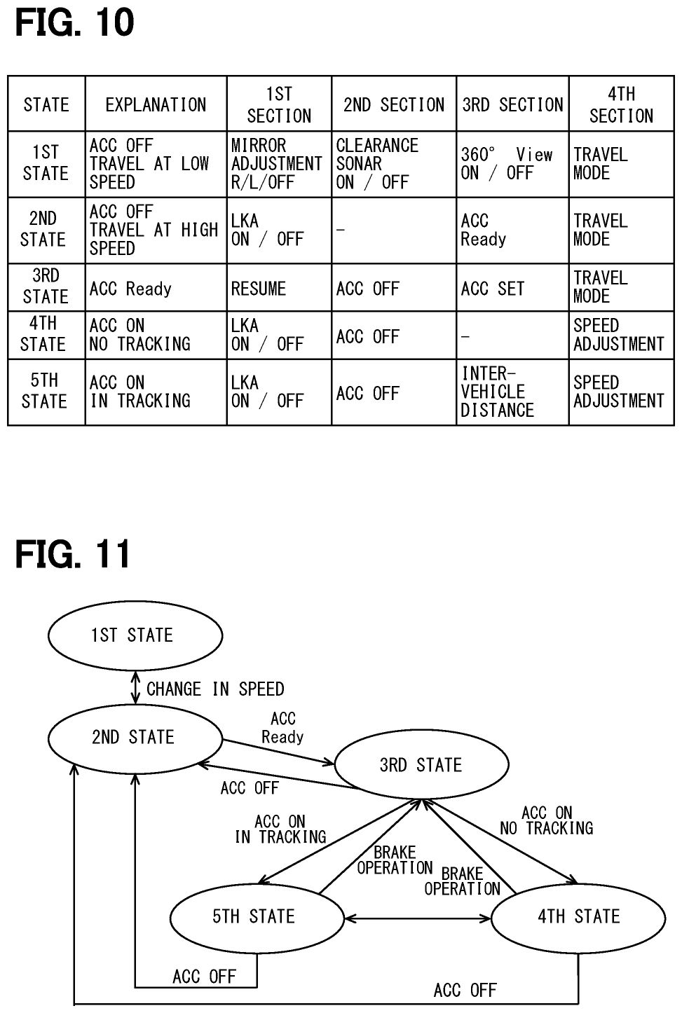

Further, the control unit 140 changes the display state (displayed or hidden) of the plurality of operation icons 22b on the display unit 22a according to the operation state of the operator's finger F, and also displays the various selection icons 22b1 by changing the assignment according to the state of the vehicle 10. As will be described later, the control unit 140 stores in advance a table as shown in FIG. 10 for the assignment of the various selection icons 22b1 according to the state of the vehicle 10.

The communication IC 150 is connected to the CAN bus 20 via the interface (I/F) 151, acquires information necessary for the input device 100 from the CAN bus 20, and transmits the information to the control unit 140. Further, the communication IC 150 transmits each signal (position signal and pressing signal) acquired from the touch sensor 120 and the push sensor 130 on the operation surface 111 to the CAN bus 20.

The configuration of the input device 100 according to the present embodiment is as described above, and the actuation and effect will be described below with reference to FIGS. 6 to 13. In the following, it is assumed that the vehicle devices and operation icons other than the various vehicle devices 22 to 28 and the various operation icons 22b described above are also included.

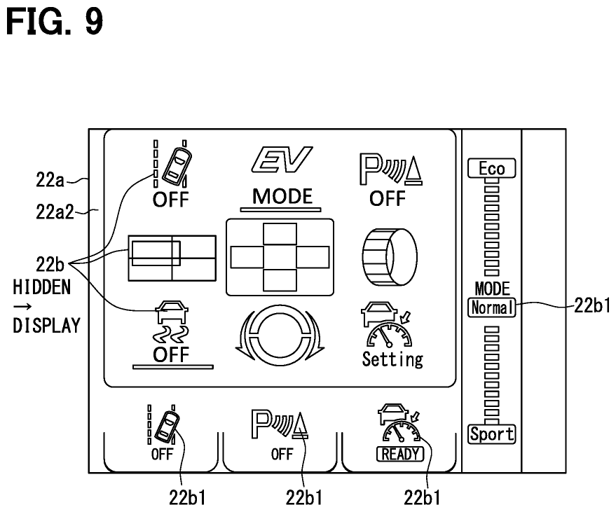

The display control for the various operation icons 22b and the various selection icons 22b1 on the display unit 22a executed by the control unit 140 will be described with reference to FIGS. 6 to 9. Examples of various operation icons 22b as shown in FIG. 9 include a lane keeping assist icon, a motor travel setting icon, a clearance sonar icon, a position adjustment icon for the display unit 22a of the HUD device 22, a return icon to a main menu, a tire pressure monitor icon, an anti-slip device icon, a vehicle height adjustment icon, a cruise control icon, and the like. Further, various selection icons 22b1 may include a lane keeping assist icon, a clearance sonar icon, a cruise control icon, a travel mode setting icon, and the like selected from the various operation icons 22b.

As shown in FIG. 6, the control unit 140 displays the selection icons 22b1 (for example, four) and hides the operation icons 22b for input operation when there is no finger operation (predetermined operation, here, touch operation) with respect to the general area 111a of the operation surface 111.

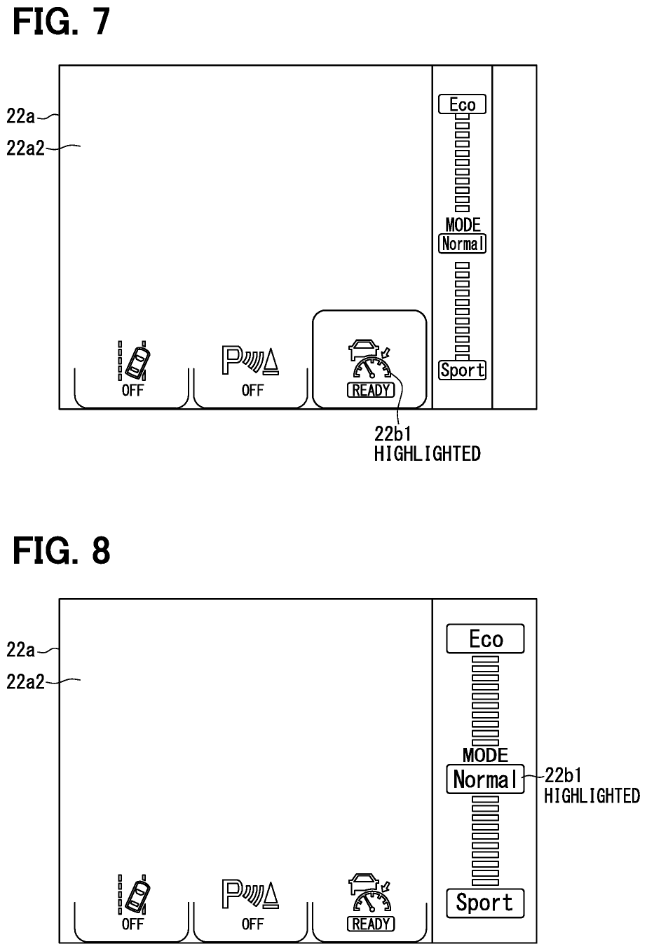

Further, as shown in FIG. 7, for example, when the operator's finger F is placed on the third section 1113 of the operation surface 111, the control unit 140 highlights the selection icon 22b1 on the corresponding position on the display unit 22a. The control unit 140 may highlight the selection icon 22b1 by showing a frame around the selection icon 22b1.

Further, as shown in FIG. 8, for example, when the operator's finger F is placed on the forth section 1114 of the operation surface 111, the control unit 140 highlights the selection icon 22b1 on the corresponding position on the display unit 22a. The control unit 140 may highlight the selection icon 22b1 by zooming in on the selection icon 22b1.

Further, as shown in FIG. 9, for example, when the operator's finger F is placed on the general area 111a of the operation surface 111 (a predetermined operation, here, when there is a touch operation), the control unit 140 displays the operation icons 22b on the display unit 22a.

Next, the diagram shown in FIG. 10 will be described. As shown in FIG. 10, for example, an icon with a higher necessity for input operation according to the traveling speed of the vehicle 10 and the setting state of the cruise control as the state of the vehicle 10 is assigned as the selection icon 22b1. The selection icon 22b1 is displayed on each section 1111 to 1114 of the operation surface 111 in the display unit 22a. Hereinafter, the diagram of FIG. 10 will be referred to as an assignment table. The assignment table may divide the state of the vehicle 10 into a first state to a fifth state. The allocation of the selection icon 22b1 corresponding to each section 1111 to 1114 is determined for each of the first to fifth states.

It is assumed that, in the first state, the vehicle travels at low speed and cruise control (ACC) is off. In the first state, a door mirror adjustment icon is assigned as the selection icon 22b1 corresponding to the first section 1111, a clearance sonar icon is assigned as the selection icon 22b1 corresponding to the second section 1112, a 360-degree view monitor icon is assigned as the selection icon 22b1 corresponding to the third section 1113, and a traveling mode setting icon is assigned as the selection icon 22b1 corresponding to the fourth section 1114.

It is assumed that, in the second state, the vehicle travels at high speed and cruise control is off. In the second state, a lane keeping assist (LKA) icon is assigned as the selection icon 22b1 corresponding to the first section 1111, no icon is assigned as the selection icon 22b1 corresponding to the second section 1112, a cruise control ready state (Ready) icon is assigned as the selection icon 22b1 corresponding to the third section 1113, and the traveling mode setting icon is assigned as the selection icon 22b1 corresponding to the fourth section 1114.

It is assumed that, in the third state, the vehicle travels at high speed and cruise control is ready. In the third state, an icon for returning to the cruise control condition (ACC Ready) after the brake operation is assigned as the selection icon 22b1 corresponding to the first section 1111, a cruise control off is assigned as the selection icon 22b1 corresponding to the second section 1112, a cruise control set icon is assigned as the selection icon 22b1 corresponding to the third section 1113, and the traveling mode setting icon is assigned as the selection icon 22b1 corresponding to the fourth section 1114.

It is assumed that, in the fourth state, the vehicle travels at high speed, the cruise control is on, and the subject vehicle does not track a vehicle in front. In the fourth state, the lane keeping assist icon is assigned as the selection icon 22b1 corresponding to the first section 1111, the cruise control off is assigned as the selection icon 22b1 corresponding to the second section 1112, no icon is assigned as the selection icon 22b1 corresponding to the third section 1113, and a speed adjustment icon is assigned as the selection icon 22b1 corresponding to the fourth section 1114.

It is assumed that, in the fourth state, the vehicle travels at high speed, the cruise control is on, and the subject vehicle tracks a vehicle in front. In the fifth state, the lane keeping assist icon is assigned as the selection icon 22b1 corresponding to the first section 1111, the cruise control off is assigned as the selection icon 22b1 corresponding to the second section 1112, an icon for setting the inter-vehicle distance is assigned as the selection icon 22b1 corresponding to the third section 1113, and the speed adjustment icon is assigned as the selection icon 22b1 corresponding to the fourth section 1114.

FIG. 11 shows the transition of the state of the vehicle 10 among the first state to the fifth state. The first state indicates a low-speed traveling state. When the speed exceeds a predetermined speed, the state transitions to the second state. In the second state, when the preparation state of the cruise control is set, the state transitions to the third state. In the third state, when the cruise control is turned off, the state returns to the second state.

When the cruise control is turned on in the third state and there is no tracking of the vehicle in front, the state transitions to the fourth state. When the brake is operated in the fourth state, the state returns to the third state. When the cruise control is turned on in the third state and there is tracking of the vehicle in front, the state transitions to the fifth state. When the brake is operated in the fifth state, the state returns to the third state. In addition, the fourth state and the fifth state are switched depending on whether or not the subject vehicle tracks the vehicle in front. Further, when the cruise control is turned off in the fourth or fifth state, the state returns to the second state. Such a change in the state of the vehicle 10 is reflected in the assignment table.

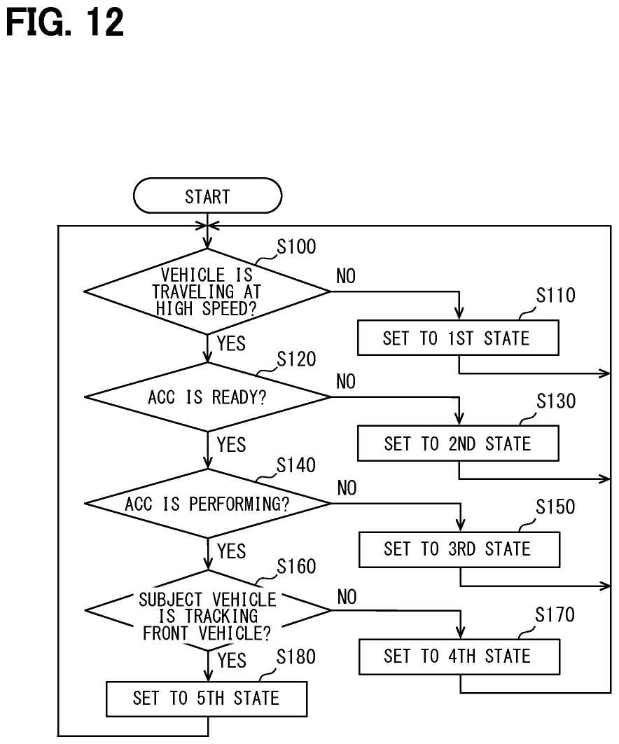

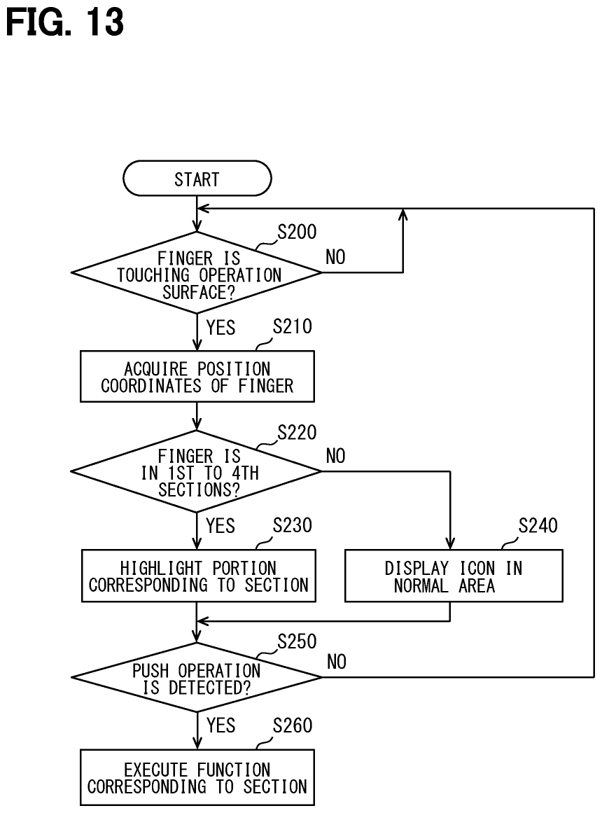

Next, the control contents performed by the control unit 140 will be described with reference to the flowcharts of FIGS. 12 and 13.

First, in S100 of FIG. 12, the control unit 140 determines whether the vehicle 10 is traveling at high speed. For the vehicle speed, for example, speed data in the meter device 24 can be used. When the control unit 140 determines that the vehicle speed is not equal to or higher than a predetermined speed (low-speed traveling), the control unit 140 sets the state to the first state in the assignment table (FIG. 10) in S110. In the first state, various selection icons 22b1 are assigned and displayed on the display unit 22a.

When an affirmative determination is made in S100, the control unit 140 determines in S120 whether the cruise control is ready. When a negative determination is made in S120, the control unit 140 sets the second state in the assignment table (FIG. 10) in S130. The control unit 140 assigns each selection icon 22b1, and causes the display unit 22a to display each selection icon 22b1.

When an affirmative determination is made in S120, the control unit 140 determines in S140 whether the cruise control is being performed. When a negative determination is made in S140, the control unit 140 sets the third state in the assignment table (FIG. 10) in S150. The control unit 140 assigns each selection icon 22b1, and causes the display unit 22a to display each selection icon 22b1.

When an affirmative determination is made in S140, the control unit 140 determines in S160 whether the vehicle 10 tracks the vehicle in front in the cruise control. When a negative determination is made in S160, the control unit 140 sets the fourth state in the assignment table (FIG. 10) in S170. The control unit 140 assigns each selection icon 22b1, and causes the display unit 22a to display each selection icon 22b1.

When an affirmative determination is made in S160, the control unit 140 sets the fifth state in the assignment table (FIG. 10) in S180. The control unit 140 assigns each selection icon 22b1, and causes the display unit 22a to display each selection icon 22b1.

In addition to the control flow of FIG. 12, the control unit 140 executes the control flow of FIG. 13. In S200, the control unit 140 determines whether the finger F is in contact with the operation surface 111. When an affirmative determination is made in S200, the control unit 140 acquires the position coordinates of the finger F in S210. When a negative determination is made in S200, the processing repeats S200.

Next, in S220, the control unit 140 determines whether the acquired position coordinates of the finger F correspond to any of the first to fourth sections 1111 to 1114. When an affirmative determination is made in S220, the control unit 140, in S230, highlights the selection icon 22b1 in the display unit 22a corresponding to any one of the sections 1111 to 1114 where the finger F is located as described in FIGS. 7 and 8.

When a negative determination is made in S220, that is, the position coordinates where the finger F is located is in the general area 111a and there is a touch operation in the general area 111a, the control unit 140, in S240, causes the display unit 22a to display the icons corresponding to the general area 111a, that is, the plurality of operation icons 22b as described with reference to FIG. 9. In other words, the control unit 140 keeps the display state of the plurality of operation icons 22b corresponding to the general area 111a hidden until there is a touch operation in the general area 111a.

Then, in S250, when the control unit 140 detects the pushing operation on the operation surface 111, the control unit 140 executes the function of the selection icon 22b1 corresponding to the pushed section (any one of sections 1111 to 1114). When a negative determination is made in S250, the processing returns to S200.

As described above, in the present embodiment, the control unit 140 hides the plurality of operation icons 22b of the display unit 22a corresponding to the general area 111a until a touch operation (predetermined operation) by the finger F is performed on the general area 111a of the operation surface 111. Therefore, there is no information overload for the operator. The operator can cause the display unit 22a to display the plurality of operation icons 22b by performing a touch operation (predetermined operation) on the general area 111a as necessary.

Further, the control unit 140 changes the assignment to the selection icons 22b1 corresponding to the plurality of sections 1111 to 1114 according to the state of the vehicle 10 and causes the display unit 22a to display the selection icons 22b1. Thus, the control unit 140 can select the icons suitable for the state of the vehicle 10 among the plurality of the operation icons 22b and improve the operability. In addition, since the protrusion unit 112 is provided on each of the plurality of sections 1111 to 1114, the operator can operate each of the plurality of sections 1111 to 1114 by the feeling of the finger F without directly looking at the plurality of sections 1111 to 1114. Thus, the configuration can improve the operability. The configuration can suppress eyesore for overloaded information and reduce an operation load.

Further, the state of the vehicle 10 includes the traveling speed of the vehicle 10 and the setting state of the cruise control. As a result, the selection icon 22b1 can be assigned according to the traveling speed and the setting state of the cruise control. Thus, the usability can be improved.

Further, each selection icon 22b1 is set as the operation icon 22b that has highly required for the input operation according to the state of the vehicle 10. As a result, the display unit 22a displays the selection icons 22b1 each has highly required for the input operation corresponding to sections 1111 to 1114 of the operation surface 111 according to the state of the vehicle 10. Thus, the selection icons 22b1 helps the operator to save the trouble of searching for the operation icon 22b to be used from the plurality of operation icons 22b, and the usability can be improved.

Further, when an operation by the finger F is input to any one of the plurality of the sections 1111 to 1114, the control unit 140 highlights the corresponding selection icon 22b1 of the display unit 22a. As a result, the configuration can easily recognize the selection icon 22b1 currently being operated.

Further, the general area 111a on the operation surface 111 displays the plurality of operation icons 22b fixed on the display unit 22a regardless of the state of the vehicle 10. As a result, the operation for each of the plurality of basic operation icons 22b can be performed in the general area 111a regardless of the state of the vehicle 10.

### Second Embodiment

In the first embodiment, when the various selection icons 22b1 are assigned to the sections 1111 to 1114 on the operation surface 111, the state of the vehicle 10, specifically, the traveling speed of the vehicle 10 and the setting state of the cruise control is referenced.

However, the reference is not limited to the state of the vehicle 10. The reference may include at least one of a state outside the vehicle, a guidance route information item for guiding the vehicle 10 to the destination, characteristic of the operator who operates the finger F, a frequency of the operation, and an operation condition of each of the vehicle devices 22 to 28.

The state outside the vehicle may include a traveling state of surrounding vehicles, and a type of road on which the vehicle is traveling (general road, highway, living road, etc.).

The guide route information item may include information such as “highway continue for a while”, “curve continue”, or “there is a blind angle area at the nearest intersection”.

The characteristics of the operator may indicate those who are accustomed to handling the input device 100, those who are not accustomed to handling the input device 100, and the like.

The frequency of operations may include frequency data indicating which operation icon 22b (selection icon 22b1) is used more frequently during a predetermined period.

The operation condition of the various vehicle devices 22 to 28 may include data indicating which vehicle device is currently in operation when the operator touches the operation surface 111.

By adding the condition, the variation of the assignment of the selection icons 22b1 can be further increased, and the usability can be improved.

### Other Embodiments

In each embodiment, the operation unit 110 is the touch pad type. However, it is not limited to the touch pad type. The operation unit 110 may be a touch panel type in which the center display 23a of the navigation device 23 may be transparent and the display may be visually recognized in the operation surface 111.

In each of the above embodiments, it is described that the operation object is the finger F of the operator. Alternatively, a pen-like stick for inputting an operation may function as the operation object.

A flowchart or a process of the flowchart described in the present disclosure includes multiple parts (or steps), and each part is expressed, for example, as S100. Furthermore, each part may be divided into multiple sub-parts, while the multiple parts may be combined into one part. Each of these sections may also be referred to as a circuit, a device, a module, or means.

Each of the plurality of sections or some of the sections combined to each other can be embodied as (i) a software section combined with a hardware unit (e.g., a computer) or (ii) a hardware section (e.g., an integrated circuit or a wiring logic circuit) including or excluding a function of a relevant device. The hardware section may still alternatively be installed in a microcomputer.

What is claimed is:

1. An input device comprising:
a display unit provided on a predetermined device mounted on a vehicle and configured to display information related to the vehicle;
a detection unit configured to detect a position of an operation body on an operation surface;
a press detection unit configured to detect a press state of the operation body on the operation surface; and
a control unit configured to (i) cause the display unit to display a plurality of operation icons for input operation, (ii) associate the operation body on the operation surface with one of the plurality of operation icons, and (iii) perform an input to the predetermined device according to an operation state of the operation body detected by the detection unit and the press detection unit, wherein
the operation surface includes a general area and a sectioned area having a plurality of sections,
the general area corresponds to an area of the display unit which displays the plurality of operation icons and each of the plurality of sections corresponds to an area of the display unit which displays a selection icon selected from the plurality of operation icons,
each of the plurality of sections is provided with a perception unit configured to give a perception to the operation body when the operation body touches the perception unit,
the control unit causes the display unit to hide the plurality of operation icons corresponding to the general area until a predetermined operation is performed by the operation body on the general area, and
the control unit causes the display unit to display the selection icon by changing an assignment of the selection icon according to a vehicle state.

2. The input device according to claim 1, wherein
the vehicle state includes a traveling speed of the vehicle and a setting state of cruise control.

3. The input device according to claim 1, wherein
the control unit changes the assignment of the selection icon according to, in addition to the vehicle state, at least one of a state outside the vehicle, a guidance route information item for guiding the vehicle to a destination, a characteristic of an operator who operates the operation body, a frequency of operation, and an operation state of the predetermined device.

4. The input device according to claim 1, wherein
one of the plurality of operation icons with a higher need for input operation is assigned to the selection icon according to the vehicle state.

5. The input device according to claim 1, wherein
when the operation body performs an operation to one of the plurality of sections, the control unit highlights a selection icon corresponding to the section.

6. The input device according to claim 1, wherein
the general area corresponds to the area of the display unit which displays the plurality of operation icons fixed regardless of the vehicle state.

7. An input device comprising:
a display provided on a predetermined device mounted on a vehicle and configured to display information related to the vehicle;
a position sensor configured to detect a position of an operation body on an operation surface;
a press detection sensor configured to detect a press state of the operation body on the operation surface; and
a processor configured to (i) cause the display to display a plurality of operation icons for input operation, (ii) associate the operation body on the operation surface with one of the plurality of operation icons, and (iii) perform an input to the predetermined device according to the position of an operation body and the press state of the operation body, wherein
the operation surface includes a general area and a sectioned area having a plurality of sections,
the general area corresponds to an area of the display which displays the plurality of operation icons and each of the plurality of sections corresponds to an area of the display which displays a selection icon selected from the plurality of operation icons,
each of the plurality of sections is provided with a perception unit configured to give a perception to the operation body when the operation body touches the perception unit,
the processor causes the display to hide the plurality of operation icons corresponding to the general area until a predetermined operation is performed by the operation body on the general area, and
the processor causes the display to display the selection icon by changing an assignment of the selection icon according to a vehicle state.
